(19) United States
(12) Patent Application Publication
(10) Pub. No.: US 2007/0200822 A1
(43) Pub. Date: Aug. 30, 2007

(54) Information processing apparatus and light projection control method

(76) Inventor: Kageyuki Iso, Akishima-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/707,335

(22) Filed: Feb. 16, 2007

(30) Foreign Application Priority Data
Feb. 28, 2006 (JP) 2006-051525

(51) Int. Cl. G09G 5/00

(52) U.S. Cl. 345/156

(57) ABSTRACT

According to one embodiment, there is provided an information processing apparatus, including a projecting portion to project visible light indicative of at least one of a first input device and a second input device, and a switch to designate the at least one of the first input device and the second input device to be projected as visible light from the projecting portion.

### CROSS-REFERENCE TO RELATED APPLICATIONS

This application is based upon and claims the benefit of priority from Japanese Patent Application No. 2006-051525, filed Feb. 28, 2006, the entire contents of which are incorporated herein by reference.

### BACKGROUND

1. Field

One embodiment of the invention relates to an information processing apparatus, which is configured to form an image of an input apparatus by projecting visible light and a light projection control method.

2. Description of the Related Art

An information processing apparatus, for example, a personal computer, generally has an input device, such as a keyboard or a touch pad.

In recent years, a type of information processing apparatus forms a projection image of an input apparatus on a surface of an object by projecting visible light, such as red laser light, instead of the aforementioned input device. The projection image is called a virtual input device or a pseudo input device.

For example, Jpn. PCT National Publication No. 2004-513416 discloses a technique of forming a virtual keyboard by projection light, and discriminating a virtual key that the user touches.

However, according to the conventional art, if the user wishes to change the virtual keyboard in use to another input device (e.g., a tablet), the user's wish cannot be fulfilled.

Further, when a virtual touch pad image and a virtual keyboard image are formed, the user may touch the virtual touch pad by mistake while operating the virtual keyboard. In this case, an operation error may occur.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary front view showing a state in which a display unit of a computer according to an embodiment of the invention is opened;

FIG. 2 is an exemplary block diagram showing a system configuration of the computer;

FIG. 3 is an exemplary diagram for explaining modes of combinations of virtual input devices available in the computer;

FIG. 4 is an exemplary block diagram showing a configuration of elements concerned with a process of switching the modes shown in FIG. 3;

FIG. 5 is an exemplary diagram showing a table containing layout information corresponding to the respective modes;

FIGS. 6A, 6B and 6C are exemplary diagrams showing images of layouts formed by a light projection section; and

FIG. 7 is an exemplary flowchart showing operations of light projection control according to the embodiment of the invention.

### DETAILED DESCRIPTION

Various embodiments according to the invention will be described hereinafter with reference to the accompanying drawings. In general, according to one embodiment of the invention, there is provided an information processing apparatus, including a projecting portion to project visible light indicative of at least one of a first input device and a second input device, and a switch to designate the at least one of the first input device and the second input device to be projected as visible light from the projecting portion.

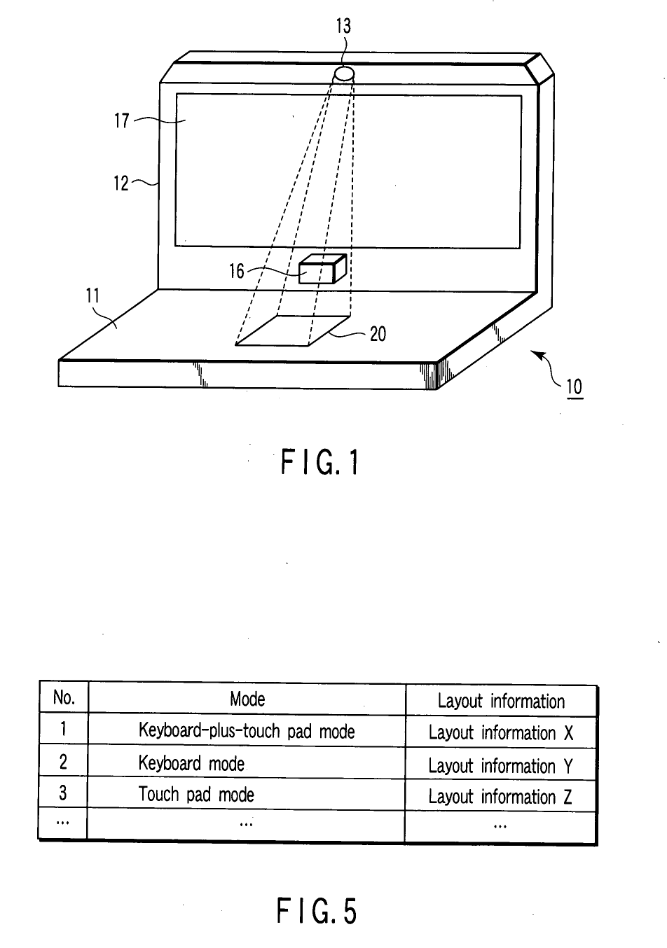

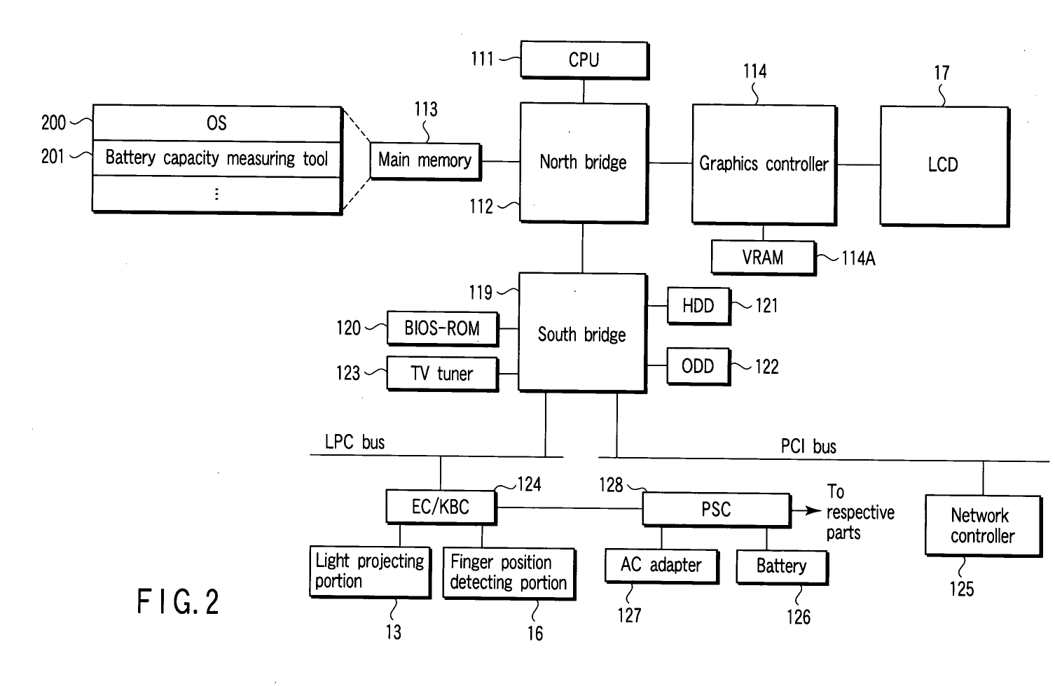

First, a configuration of an information processing apparatus according to an embodiment of the invention will be described with reference to FIGS. 1 and 2. The information processing apparatus is implemented as, for example, a notebook computer 10.

FIG. 1 is a front view showing a state in which a display unit of the notebook computer 10 is opened. The computer 10 includes a computer main body 11 and a display unit 12. The display unit 12 incorporates a display device including a thin film transistor liquid crystal display (TFT-LCD) 17. The display screen of the LCD 17 is located substantially at the center of the display unit 12.

The display unit 12 is attached to the main body 11 so as to be rotatable relative to the main body 11 between an open position and a closed position. The main body 11 has a thin box-shaped casing.

A light projection section 13 is provided in an upper portion of the display unit 12. A finger position detecting portion 16 is provided in a lower portion thereof.

The light projection section 13 projects visible light, for example, red laser light, to form an image of at least one input device (a virtual input device or a pseudo input device) on an upper surface of the computer main body 11. It also forms an image of a switch (e.g., a button), which allows the user to designate a combination of input devices to be used. The visible light is not necessarily projected onto the upper surface of the computer main body 11. For example, in the case of a personal computer like a PDA, in which the computer main body is integrated with the display unit, the visible light may be projected on a surface of a desk or the like to form an image thereon.

The finger position detecting portion 16 detects the position of a finger relative to the image formed by the light projecting portion 13. It radiates an infrared ray or an ultrasonic wave, and calculates the position of a finger based on a distance from a point at which the radiated infrared ray or ultrasonic wave is blocked by the finger and a direction (angle) of the infrared ray or ultrasonic wave.

The system configuration of the computer 10 will now be described with reference to FIG. 2.

As shown in FIG. 2, the computer 10 comprises a CPU 111, a north bridge 112, a main memory 113, a graphics controller 114, a south bridge 119, a BIOS-ROM 120, a hard disk drive (HDD) 121, an optical disc drive (ODD) 122, a TV tuner 123, an embedded controller/keyboard controller IC (EC/KBC) 124, a network controller 125, a battery 126, an AC adapter 127, a power supply controller (PSC) 128, etc.

The CPU 111 is a processor to control operations of the computer 10. It executes software, such as an operating system (OS) 200 loaded from the hard disk drive (HDD) 121 into the main memory 113 and utilities (or applications) 201 controlled by the OS.

The CPU 111 also executes a system basic input/output system (BIOS) stored in the BIOS-ROM 120. The system BIOS is a program to control hardware.

The north bridge 112 is a bridge device which connects a local bus of the CPU 111 and the south bridge 119. The north bridge 112 incorporates a memory controller which controls access to the main memory 113. The north bridge 112 also has a function of performing communication with the graphics controller 114 via an accelerated graphics port (AGP) bus or the like.

The graphics controller 114 is a display controller, which controls the LCD 17 used as a display monitor of the computer 10. The graphics controller 114 reads image data stored in a video memory (VRAM) 114A and display the data on the LCD 17.

The south bridge 119 controls devices on a low pin count (LPC) bus and devices on a peripheral component interconnect (PCI) bus. The south bridge 119 incorporates an integrated drive electronics (IDE) controller to control the HDD 121 and the ODD 122. The south bridge 119 also has a function of controlling the TV tuner 123 and controlling access to the BIOS-ROM 120.

The HDD 121 is a storage device, which stores various software and data. The optical disk drive (ODD) 122 is a drive unit to drive recording media, such as DVDs and CDs storing video contents. The TV tuner 123 is a receiving device, which receives broadcast program data, for example, TV programs, from outside.

The network controller 125 is a communication device, which executes communication with an external network, for example, the Internet.

The embedded controller/keyboard controller IC (EC/KBC) 124 is a 1-chip microcomputer, in which an embedded controller to control electric power and a keyboard controller to control an input device (including a virtual input device) are integrated. The EC/KBC 124 is connected to the light projecting portion 13 and the finger position detecting portion 16.

The power supply controller (PSC) 128 generates necessary power and supply it to the components of the computer 10 based on the power from the battery 126 or external power supplied through the AC adapter 127, in accordance with instructions from the embedded controller (EC).

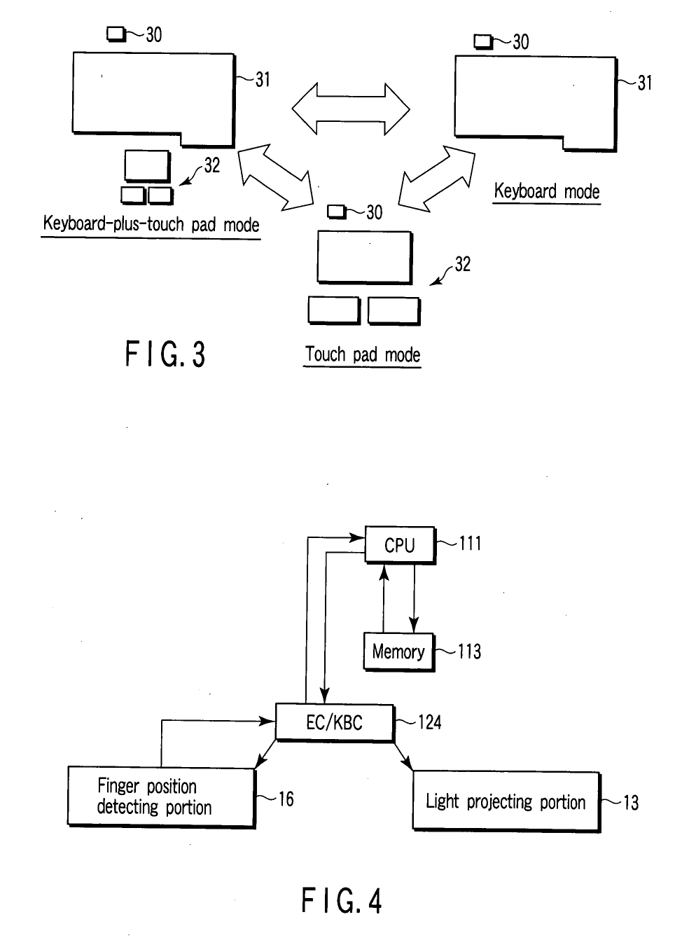

Modes of combinations of virtual input devices available in the computer 10 will now be described with reference to FIG. 3.

The virtual input devices may be, for example, a key input device (e.g., a keyboard), a pointing device (e.g., a touch pad) or a pen input device (e.g., a tablet).

The computer 10 has three modes: a keyboard-plus-touch pad mode to use a keyboard and a touch pad; a keyboard mode to use only a keyboard; and a touch pad mode to use only a touch pad. The computer 10 may also have a tablet mode to use a tablet. When the computer 10 is operating, the light projecting portion 13 projects light including layout information corresponding to the set mode, and the projected light forms an image on the upper surface of the computer main body 11. In the following, to make the explanation simple, only the three modes of the keyboard-plus-touch pad mode, the keyboard mode and the touch pad mode are described.

When the keyboard-plus-touch pad mode is set, a layout is formed, which includes a virtual mode switching button 30, a virtual keyboard 31 and a virtual touch pad 32.

When the keyboard mode is set, a layout is formed, which includes the virtual mode switching button 30 and the virtual keyboard 31.

When the touch pad mode is set, a layout is formed, which includes the virtual mode switching button 30 and the virtual touch pad 32.

The virtual mode switching button 30 is a switch used to switch among the aforementioned three modes. The virtual mode switching button 30 may be a toggle button, which toggles between modes each time it is pushed. Alternatively, a keyboard-plus-touch pad mode designating button, a keyboard mode designating button and a touch pad mode designating button may be individually provided. In this case, the mode can be changed to a desired one only by pushing the corresponding designating button once. Since the virtual mode switching button 30 is provided in all modes, the user can change the mode to a desired one at any time. For example, in the keyboard-plus-touch pad mode, if the user is liable to touch the virtual touch pad 32 by mistake, while performing an input operation using the virtual keyboard 30, the user can change the mode to the keyboard mode. Thus, the problem can be easily solved.

FIG. 4 is a block diagram showing a configuration of elements concerned with a process of switching the modes shown in FIG. 3.

The memory 113, the CPU 111, the EC/KBC 124, the light projecting portion 13 and the finger position detecting portion 16, etc. are concerned with the mode switching process.

The memory 113 stores a table containing layout information corresponding to the respective modes, for example, as shown in FIG. 5. The memory storing the table may be a RAM or a nonvolatile storage medium (a ROM etc.). Alternatively, the table of the layout information may be stored in the EC/KBC 124 or the light projecting portion 13.

The CPU 111 controls the table in the memory 113 and performs control in accordance with a request from the EC/KBC 124 or software via the utilities (or applications) controlled by the OS 200. For example, when the CPU 111 receives a request for layout information corresponding to a mode from the EC/KBC 124 or software, it reads the corresponding layout information with reference to the table in the memory 113, and transfers the read information to the EC/KBC 124.

The EC/KBC 124 recognizes the mode designated by the operation through the virtual mode switching button 30 based on the results of detection by the finger position detecting portion 16. Then, it acquires the layout information corresponding to the recognized mode from the CPU 111, to cause the light projecting portion 13 to form an image of the layout. In addition, it performs control to form the image of the layout in a range that can be detected by the finger position detecting portion 16. These processes may not be necessarily executed by the EC/KBC 124, but may be executed by another special-purpose controller. The above process of recognizing the mode may be executed by the utilities (or applications) 201 or the like.

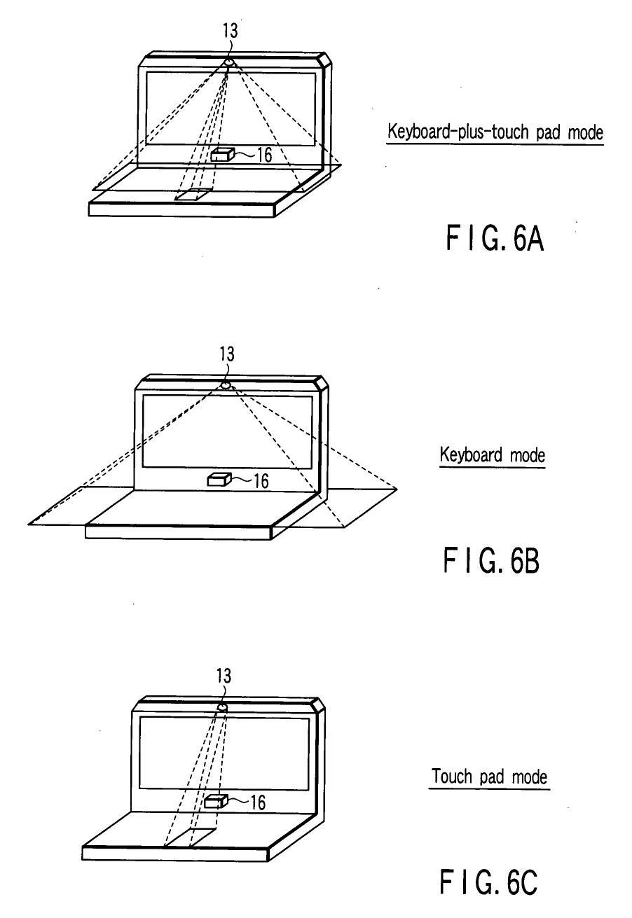

The light projecting portion 13 projects light forming a layout designated by the EC/KBC 124. For example, when the layout information of the keyboard-plus-touch pad mode is designated, the light projecting portion 13 performs the projection as shown in FIG. 6A. When the layout information of the keyboard mode is designated, the light projecting portion 13 performs the projection as shown in FIG. 6B. In preparation for the case in which the virtual keyboard to be projected has a width wider than the width of the computer main body, extension plates may be stored in the computer main body. When the extension plates are drawn out, the computer main body and the extension plates form one continuous large plane, so that the virtual keyboard can be projected on the plane. When the layout information of the touch pad mode is designated, the light projecting portion 13 performs the projection as shown in FIG. 6C.

The finger position detecting portion 16 detects the position of a finger in a detection range designated by the EC/KBC 124. For example, when the layout of the keyboard-plus-touch pad mode as shown in FIG. 6A is formed, a range including the virtual mode switching button 30, the virtual keyboard 31 and the virtual touch pad 32 is an object of detection. When the layout of the keyboard mode as shown in FIG. 6B is formed, a range including only the virtual mode switching button 30 and the virtual keyboard 31 is an object of detection. When the layout of the touch pad mode as shown in FIG. 6C is formed, a range including only the virtual mode switching button 30 and the virtual touch pad 32 is an object of detection. Thus, the finger position detecting portion 16 can properly detect the range only corresponding to the set mode.

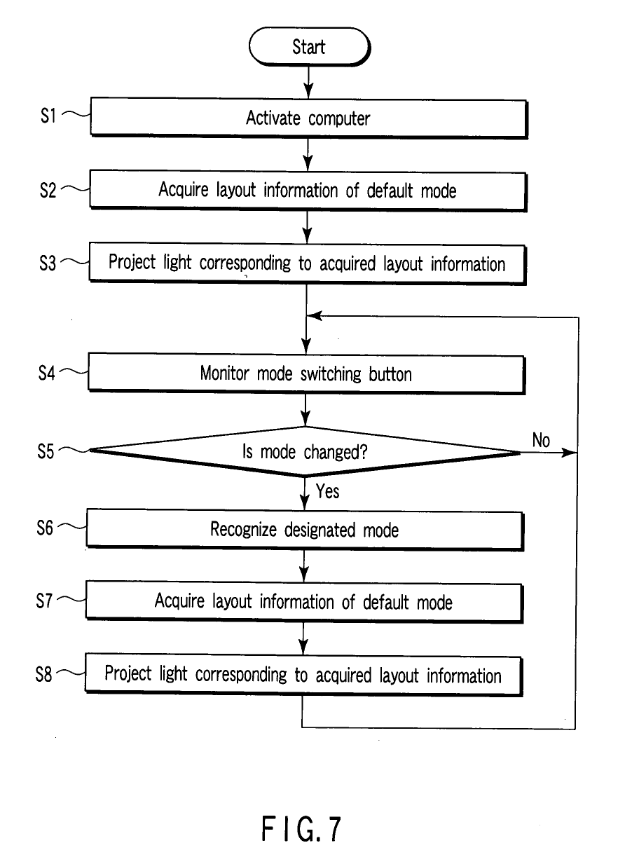

An operation of the light projection control in the embodiment will be described with reference to FIG. 7.

When the computer 10 is activated (block S1), the EC/KBC 124 recognizes a mode preset as a default in the register or the like, and acquires the corresponding layout information from the CPU 111 (block S2).

The EC/KBC 124 performs control to cause the light projecting portion 13 to project light corresponding to the acquired layout information, and to form the image of the layout in a range that can be detected by the finger position detecting portion 16. As a result, the light projecting portion 13 projects light, which forms the layout designated by the EC/KBC 124 (block S3). The finger position detecting portion 16 detects the range designated by the EC/KBC 124, and monitors a motion of a finger relative to the virtual mode switching button or the virtual input device (block S4).

If the virtual mode switching button 30 is operated (YES in block S5), the EC/KBC 124 recognizes the mode designated by the virtual mode switching button 30 based on the result of the detection by the finger position detecting portion 16 (block S6), and acquires the layout information corresponding to the recognized mode from the CPU 111 (block S7).

The EC/KBC 124 performs control to cause the light projecting portion 13 to project light corresponding to the acquired layout information, and form an image of the layout in a range that can be detected by the finger position detecting portion 16. As a result, the light projecting portion 13 projects light forming the layout designated by the EC/KBC 124 (block S8). Then, the process from blocks S4 to S8 is repeated.

As described above, according to the embodiment of the invention, since the virtual mode switching button 30 is prepared in any of the plurality of modes, the user can change the mode to a desired one at any time. For example, in the keyboard-plus-touch pad mode, if the user is liable to touch the virtual touch pad 32 by mistake, while performing an input operation using the virtual keyboard 30, the user can change the mode to the keyboard mode. Thus, the problem can be easily solved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a projecting portion to project visible light indicative of at least one of a first input device and a second input device; and
a switch to designate the at least one of the first input device and the second input device to be projected as visible light from the projecting portion.

2. The information processing apparatus according to claim 1, wherein the projecting portion further projects visible light indicative of the switch.

3. The information processing apparatus according to claim 1, wherein the projecting portion projects visible light indicative of the at least one of the first input device and the second input device in accordance with a request from software.

4. The information processing apparatus according to claim 1, wherein the at least one of the first input device and the second input device to be projected as visible light includes at least one of a key input device, a pointing device, and a pen input device.

5. An information processing apparatus, comprising:
a projecting portion to project visible light indicative of at least one input device and visible light indicative of a switch to change the at least one input device on a surface of an object;
a detecting portion to detect an operation with respect to an image formed by visible light projected on the surface of the object; and
a control portion to control the projecting portion to project visible light indicative of at least one input device designated by operating the switch and visible light indicative of the switch based on a result of detection by the detecting portion.

6. The information processing apparatus according to claim 5, wherein the control portion performs control to form an image of the input device designated by operating the switch and an image of the switch on the surface of the object in a range that can be detected by the detecting portion.

7. The information processing apparatus according to claim 5, wherein the control portion performs control of projecting the visible light indicative of the at least one input device and the visible light indicative of the switch from the projecting portion in accordance with a request from software.

8. The information processing apparatus according to claim 5, wherein the at least one input device to be projected as visible light includes at least one of a key input device, a pointing device, and a pen input device.

9. A light projection control method, comprising:
designating at least one of a first input device and a second input device; and
projecting visible light indicative of the at least one of the first input device and the second input device designated.

10. The light projection control method according to claim 9, further comprising projecting visible light indicative of a switch to designate the at least one of the first input device and the second input device together with visible light indicative of the at least one of the first input device and the second input device designated.

11. The light projection control method according to claim 9, visible light indicative of the at least one of the first input device and the second input device is projected in accordance with a request from software.

12. The light projection control method according to claim 9, wherein the at least one of the first input device and the second input device to be projected as visible light includes at least one of a key input device, a pointing device, and a pen input device.
